(19) United States
(12) Patent Application Publication
(10) Pub. No.: US 2021/0241435 A1
(43) Pub. Date: Aug. 5, 2021

(54) POINT CLOUD FUSION METHOD, ELECTRONIC DEVICE, AND COMPUTER STORAGE MEDIUM

(71) Applicant: Zhejiang Sense Time Technology Development Co., Ltd., Hangzhou (CN)

(72) Inventors: Liyang Zhou, Hangzhou (CN); Xiaojun Xiang, Hangzhou (CN); Yong Qi, Hangzhou (CN); Hanqing Jiang, Hangzhou (CN); Guofeng Zhang, Hangzhou (CN)

(21) Appl. No.: 17/239,984

(22) Filed: Apr. 26, 2021

Related U.S. Application Data
(63) Continuation of application No. PCT/CN2019/102081, filed on Aug. 22, 2019.

(30) Foreign Application Priority Data
Jul. 4, 2019 (CN) 201910601035.3

(51) Int. Cl. G06T 5/50; G06T 7/50

(52) U.S. Cl. CPC G06T 5/50; G06T 2207/20221; G06T 2207/10028; G06T 7/50

(57) ABSTRACT

A point cloud fusion method, an electronic device, and a computer storage medium are provided. The method includes: determining, according to at least two influence factors in scene information and/or camera information, depth confidences of pixel points in a current frame depth map, where the scene information and the camera information each at least includes one influence factor; and performing point cloud fusion processing on the pixel points in the current frame depth map according to the depth confidences.

### CROSS REFERENCE TO RELATED APPLICATIONS

The present application is a continuation of International Patent Application No. PCT/CN2019/102081, filed on Aug. 22, 2019, which claims priority to Chinese Patent Application No. 201910601035.3, filed on Jul. 4, 2019. The disclosures of International Patent Application No. PCT/CN2019/102081 and Chinese Patent Application No. 201910601035.3 are hereby incorporated by reference in their entireties.

### BACKGROUND

A large amount of point cloud data may be acquired by using a laser scanner or a depth camera, so as to implement reconstruction of a three-dimensional model of an object or a scene, and the cloud point data-based three-dimensional model reconstruction method may be applied to augmented reality, game, and other applications on a mobile platform, for example, functions such as online display of three-dimensional objects, scene interaction, shadow casting, and interactive collisions are implemented, and functions such as three-dimensional object recognition in the field of computer visions are also implemented.

### SUMMARY

The present disclosure relates to computer vision technologies, and in particular, to a point cloud fusion method and apparatus, an electronic device, and a non-transitory computer-readable storage medium, capable of being applied to scenes such as three-dimensional modeling, three-dimensional scenes, and augmented reality.

Embodiments of the present disclosure provide a point cloud fusion method, including: determining, according to at least two influence factors in scene information and/or camera information, depth confidences of pixel points in a current frame depth map, where the scene information and the camera information each at least includes one influence factor; and performing point cloud fusion processing on the pixel points in the current frame depth map according to the depth confidences.

The embodiments of the present disclosure further provide a point cloud fusion apparatus, which includes a determination module and a fusion module, where the determination module is configured to determine, according to at least two influence factors in scene information and/or camera information, depth confidences of pixel points in a current frame depth map, where the scene information and the camera information each at least includes one influence factor; and the fusion module is configured to perform point cloud fusion processing on the pixel points in the current frame depth map according to the depth confidences.

The embodiments of the present disclosure further provide an electronic device, which includes a processor and a memory configured to store a computer program executable by the processor, where the processor is configured to perform, when the computer program is executed, the point cloud fusion method as described above.

The embodiments of the present disclosure further provide a non-transitory computer-readable storage medium having a computer program stored thereon, where the computer program, when executed by a processor, enables the processor to implement the foregoing point cloud fusion method as described above.

The embodiments of the present disclosure further provide a computer program, where any one of the point cloud fusion methods is implemented when the computer program is executed by a processor.

### BRIEF DESCRIPTION OF THE DRAWINGS

FIG. 1 is a flowchart of a point cloud fusion method according to embodiments of the present disclosure.

FIG. 2 is a schematic diagram of a depth map obtained in embodiments of the present disclosure.

FIG. 3 is a current frame depth map subjected to depth consistency check obtained using solutions of embodiments of the present disclosure on the basis of FIG. 2.

FIG. 4 is a depth confidence map generated based on technical solutions of embodiments of the present disclosure on the basis of FIGS. 2 and 3.

FIG. 5 is a schematic diagram of fused point cloud data generated based on technical solutions of embodiments of the present disclosure on the basis of FIGS. 3 and 4.

FIG. 6 is a schematic structural composition diagram of a point cloud fusion apparatus according to embodiments of the present disclosure.

FIG. 7 is a schematic structural diagram of an electronic device according to embodiments of the present disclosure.

### DETAILED DESCRIPTION

The present disclosure is further described in detail below with reference to the accompanying drawings and embodiments. It should be understood that the embodiments provided herein are merely intended to explain the present disclosure, rather than limit the present disclosure. In addition, the embodiments provided below are some embodiments for implementing the present disclosure, but not all the embodiments for implementing the present disclosure. The technical solutions described in the embodiments of the present disclosure can be implemented in any combination form without conflicts.

It should be noted that in the embodiments of the present disclosure, the terms “comprise”, “include”, or any other variant thereof aim at covering non-exclusive “including”, so that the method or apparatus including a series of elements not only includes the elements that are explicitly recited, but also includes other elements that are not explicitly listed, or also includes the elements inherent to the implementation of the method or the apparatus. If no more limitations is made, an element defined by a phrase “including one . . . ” does not exclude that there are other relevant elements in the method or apparatus including the elements (for example, steps in the method or units in the apparatus; the units can be a part of a circuit, a part of a processor, a part of a program or software, etc.).

For example, the point cloud fusion method provided by the embodiments of the present disclosure includes a series of steps, but is not limited to the recited steps. Similarly, the point cloud fusion apparatus provided by the embodiments of the present disclosure includes a series of modules, but is not limited to the explicitly recited modules, and may also include modules configured for obtaining related information or required when processing is performed based on information.

The embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the systems, and the like.

The electronic devices such as terminal devices, computer systems, and servers may be described in the general context of computer system executable instructions (such as, program modules) executed by the computer systems. Generally, the program modules may include routines, programs, target programs, components, logics, data structures, and the like for performing specific tasks or implementing specific abstract data types. The computer systems/servers may be practiced in distributed cloud computing environments in which tasks are performed by remote processing devices that are linked through a communications network. In the distributed computing environments, the program modules may be located in local or remote computing system storage media including storage devices.

Problems related to the solution of point cloud fusion are exemplarily illustrated as follows. For point cloud data acquired by a laser scanner, a simple point cloud fusion method is to simplify point cloud fusion by using an octree. According to this method, points falling in a same voxel are subjected to weighted average, and a case in which the same voxel covers different areas of an object may usually happen, particularly in a fine structure. Simple weighted average cannot distinguish fine structures. In some dense Simultaneous Localization and Mapping (SLAM) applications, images from different view angles usually include a large area of overlap, and existing point cloud fusion methods either relate to simply fusing depth values of the overlapping area, which may result in that areas having low reliability are also mistakenly fused, or relate to performing fusion according to depth confidences, where the depth confidences are calculated according to local structures or scene texture of the point cloud, however, the depth confidences calculated using this method are not reliable, for example, for weak texture areas, accurate depth confidences cannot be obtain by using a scene texture-based depth confidence calculation method.

In addition, in a mobile platform, the point cloud fusion process is usually required to be displayed online in real time, which also poses a great challenge to the calculation efficiency of point cloud fusion.

With regard to the technical problems, the embodiments of the present disclosure provide a point cloud fusion method. The execution subject of the point cloud fusion method may be a point cloud fusion apparatus. For example, the image depth estimation method may be executed by terminal devices or servers or other electronic devices, where the terminal devices may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementation modes, the image depth estimation method may be implemented by invoking, by a processor, computer readable instructions stored in a memory. The point cloud fusion method provided by the present disclosure may be applied to fields such as three-dimensional modeling, augmented reality, image processing, photographing, games, animation, films and television, e-commerce, education, house property, and home decoration. In the embodiments of the present disclosure, the mode for obtaining point cloud data is not limited. Using technical solutions of the embodiments of the present disclosure, continuous video frames may be acquired by using a camera. When camera poses and depth maps of the continuous video frames are known, thigh-precision point cloud data may be obtained by fusing the multi-view depths.

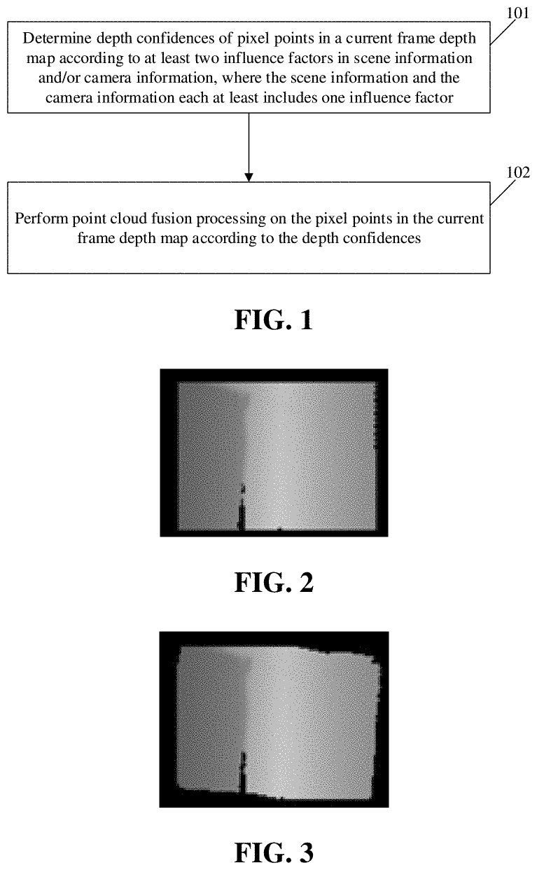

FIG. 1 is a flowchart of a point cloud fusion method according to embodiments of the present disclosure. As shown in FIG. 1, the flow includes the following steps.

At step 101: depth confidences of pixel points in a current frame depth map are determined according to at least two influence factors in scene information and/or camera information, where the scene information and the camera information each at least includes one influence factor.

In the embodiments of the present disclosure, the mode for obtaining the current frame depth map is not limited, for example, the current frame depth map may be input by a user by means of human-computer interaction. FIG. 2 is a schematic diagram of a depth map obtained in embodiments of the present disclosure.

At step 102: point cloud fusion processing is performed on the pixel points in the current frame depth map according to the depth confidences.

Steps 101 and 102 may be implemented by using a processor in an electronic device. The foregoing processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor.

It can be seen that in the embodiments of the present disclosure, the depth confidence of the pixel point is determined by comprehensively considering a plurality of factors, therefore, the reliability of the depth confidence is improved, and moreover, the reliability of point cloud fusion is improved. Here, point cloud fusion processing indicates performing data fusion on a plurality of pieces of point cloud data under a unified global coordinate system. In the data fusion process, redundant overlapping parts are required to be filtered out, so as to maintain a reasonable quantity of the entire point cloud. In the embodiments of the present disclosure, the implementation mode for point cloud fusion processing is not limited. In one example, the point cloud data may be processed based on an octree structure, so as to implement point cloud fusion.

Regarding the implementation mode of step 101, exemplarily, at least one depth-valid pixel point in the current frame depth map is obtained, and according to the at least two influence factors in the scene information and/or the camera information, a depth confidence of each depth-valid pixel point is determined.

Correspondingly, regarding the implementation mode of step 102, exemplarily, point cloud fusion processing is performed on the at least one depth-valid pixel point in the current frame depth map according to the depth confidences.

Specifically, it may be determined whether the depth of a pixel point in the current frame depth map in advance, for example, manually or using a reference frame comparison mode, and then the depth confidence of the depth-valid pixel point is determined according to the at least two influence factors in the scene information and/or the camera information, so as to perform point cloud fusion on the depth-valid pixel point. It can be seen that in the embodiments of the present disclosure, the process of point cloud fusion processing is implemented on the basis of the depth-valid pixel point, and therefore, the reliability of point cloud fusion processing is enhanced.

Optionally, after at least one reference frame depth map is obtained, whether the depth of the pixel point in the current frame depth map is valid is detected according to the at least one reference frame depth map, a depth-invalid pixel point in the current frame depth map is discarded, and the depth-valid pixel point is reserved, so that point cloud fusion is performed according to the depth-valid pixel point subsequently, thus depth-invalid point cloud is deleted, the precision and accuracy of point cloud fusion are improved, the processing speed of point cloud fusion is also improved, and real-time display of point cloud fusion is facilitated.

Optionally, the at least one reference frame depth map may include at least one frame depth map obtained before obtaining the current frame depth map. In one specific example, the at least one reference frame depth map includes depth maps of N previous frames adjacent to the current frame depth map, where N is an integer greater than or equal to 1, optionally, 1≤N≤7.

That is to say, regarding the current frame depth map, the depth maps of the N previous adjacent frames may be taken as the reference frame depth maps.

It can be seen that in the embodiments of the present disclosure, according to a depth map obtained before obtaining the current frame depth map, whether the depth of a pixel point in the current frame depth map is valid is determined, and therefore, by taking the depth map obtained before obtaining the current frame depth map as a basis, whether the depth of the pixel point in the current frame depth map is valid is determined accurately.

Regarding the implementation mode for detecting, according to the at least one reference frame depth map, whether the depth of the pixel point in the current frame depth map is valid, exemplarily, depth consistency check is performed on the depths of the pixel points in the current frame depth map by using the at least one reference frame depth map; the pixel point passing the depth consistency check is determined as depth-valid, and the pixel point not passing the depth consistency check is determined as depth-invalid.

Here, the depth consistency check may be checking whether a difference in depth between the pixel point in the current frame depth map and a corresponding pixel point in the reference frame depth map falls within a preset range, if the difference falls within the preset range, the pixel point is determined as depth-valid, otherwise, the pixel point is determined as depth-invalid.

It can be seen that in the embodiments of the present disclosure, whether the depth of the pixel point in the current frame depth map is valid is determined by means of the depth consistency check, and therefore, whether the depth of the pixel point in the current frame depth map is valid is determined accurately.

Here, after the depth-invalid pixel point in the current frame depth map is discarded, the current frame depth map subjected to depth consistency check is obtained. FIG. 3 is a current frame depth map subjected to depth consistency check obtained using solutions of embodiments of the present disclosure on the basis of FIG. 2.

In some implementation modes, one reference frame depth map is obtained, then whether the pixel point in the current frame depth map and the corresponding pixel point in the reference frame depth map satisfy a depth consistency condition is determined, if the pixel point in the current frame depth map and the corresponding pixel point in the reference frame depth map satisfy the depth consistency condition, the pixel point is determined as depth-valid, otherwise, the pixel point is determined as depth-invalid.

In some embodiments, a plurality of reference frame depth maps are obtained, and whether a first pixel point in the current frame depth map and a corresponding pixel point in each of the reference frame depth maps satisfy a depth consistency condition is determined, the first pixel point being any one pixel point in the current frame depth map.

If the quantity of the corresponding pixel points satisfying the depth consistency condition with the first pixel point is greater than or equal to a set value, it is determined that the first pixel point passes the depth consistency check; and if the quantity of the corresponding pixel points satisfying the depth consistency condition with the first pixel point is less than a set value, it is determined that the first pixel point does not pass the depth consistency check.

Here, the depth consistency condition may be that: the difference in depth between the pixel point in the current frame depth map and the corresponding pixel point in the reference frame depth map is lower than the a preset range.

In the embodiments of the present disclosure, by determining whether the first pixel point in the current frame depth map and the corresponding pixel point in each of the reference frame depth maps satisfy the depth consistency condition, the quantity of the corresponding pixel points satisfying the depth consistency condition with the first pixel point is determined. For example, if the first pixel point in the current frame depth map and the corresponding pixel points in M reference frame depth maps satisfy the depth consistency condition, the quantity of the corresponding pixel points satisfying the depth consistency condition with the first pixel point is M.

The set value may be determined according to actual needs. For example, the set value may be 50%, 60%, or 70% of the total quantity of the reference frame depth maps.

It can be seen that in the embodiments of the present disclosure, according to the quantity of the corresponding pixel points satisfying the depth consistency condition with the first pixel point, whether the first pixel point passes the depth consistency check is determined. If the quantity of the corresponding pixel points satisfying the depth consistency condition with the first pixel point is high, it is considered that the first pixel point passes the depth consistency check, otherwise, it is considered that the first pixel point does not pass the depth consistency check. In this way, the robustness and reliability of the depth consistency check are improved.

Regarding the implementation mode for determining whether the first pixel point in the current frame depth map and the corresponding pixel point in each of the reference frame depth maps satisfy the depth consistency condition, in the first example, the first pixel point is projected to each reference frame depth map to obtain the projection position and projection depth of a projection point in each reference frame depth map, and a measured depth value of the projection position in each of the reference frame depth maps is obtained. Due to errors of a depth sensor and possible noise interference in data transmission, a small difference usually exists in the projection depth corresponding to each reference frame and the measured depth value of the projection position. Here, the projection depth indicates a depth value obtained by performing projection of a pixel point between different depth maps, and the measured depth indicates an actual depth value measured by using a measurement device at the projection position.

At the time of determining whether a pixel point satisfies the depth consistency condition, a first set depth threshold is set; the difference between the projection depth of the projection point in each reference frame depth map and the measured projection depth at the projection position is obtained; if the difference is less than or equal to the first set depth threshold, it is determined that the first pixel point and the corresponding pixel point in the corresponding reference frame depth map satisfy the depth consistency condition; if the difference is greater than the first set depth threshold, it is determined that the first pixel point and the corresponding pixel point in the corresponding reference frame depth map do not satisfy the depth consistency condition.

In some other embodiments, regarding the implementation mode for determining whether the pixel point in the current frame depth map and the corresponding pixel point in each reference frame depth map satisfy the depth consistency condition, the pixel point in the reference frame depth map is projected to the current frame depth map to obtain the projection position and projection depth in the current frame depth map; the measured depth value of the projection position in the current frame depth map is obtained; the difference between the projection depth of the projection point and the measured depth value of the projection position in the current frame depth map is obtained; if the difference between the projection depth of the projection point and the measured depth value of the projection position in the current frame depth map is less than a second set depth threshold, it is determined that the pixel point in the current frame depth map and the corresponding pixel point in each of the reference frame depth maps satisfy the depth consistency condition, otherwise, it is determined that the pixel point in the current frame depth map and the corresponding pixel point in each of the reference frame depth maps do not satisfy the depth consistency condition.

In some other embodiments, regarding the implementation mode for determining whether the pixel point in the current frame depth map and the corresponding pixel in each of the reference frame depth maps satisfy the depth consistency condition, the pixel point in the reference frame depth map and the corresponding pixel point in the current frame depth map are both projected to a three-dimensional space, and then the pixel point in the reference frame depth map is compared with the corresponding pixel depth in the current frame depth map to obtain a depth difference; and if the depth difference is less than a third set depth threshold, it is determined that the pixel point in the current frame depth map and the corresponding pixel point in each of the reference frame depth maps satisfy the depth consistency condition, otherwise, it is determined that the pixel point in the current frame depth map and the corresponding pixel point in each of the reference frame depth maps do not satisfy the depth consistency condition.

Here, the first set depth threshold, the second set depth threshold, and the third set depth threshold may be pre-determined according to actual application needs, and any two of the first set depth threshold, the second set depth threshold, and the third set depth threshold may be identical, or different. In one specific example, the value range of the first set depth threshold, the second set depth threshold, or the third set depth threshold may be 0.025 m to 0.3 m. The first set depth threshold, the second set depth threshold, or the third set depth threshold are recorded as τ, τ=0.01*(d′ₘₐₓ−d′ₘᵢₙ), where (d′ₘᵢₙ, d′ₘₐₓ) is an effective range of a depth sensor, for example, (d′ₘᵢₙ, d′ₘₐₓ)=(0.25 m, 3 m).

As photographing view angles of a camera are different, the same object at a certain position may be blocked in the current frame depth map but is not blocked in another reference frame depth map. At this time, a difference of a depth of a pixel point at said position in the current frame depth map and a depth of a pixel point at the corresponding position in the reference frame depth map is large, and the reliability of the depth of the pixel point at said position is low. The precision of fusion may be reduced if the pixel point is used for point cloud fusion. In order to reduce the problem of fusion precision reduction caused by blocking, in the present disclosure, a difference between a projection depth of a projection point in each reference frame depth map and a measured projection depth at a projection position is first determined, if the difference is small, it is determined that the first pixel point and the corresponding pixel point in the corresponding reference frame depth map satisfy the depth consistency condition, otherwise, it is determined that the first pixel point and the corresponding pixel point in the corresponding reference frame depth map do not satisfy the depth consistency condition. In this way, the influence in the reliability of a depth of a pixel point due to a certain position being blocked in a current frame depth map is reduced, and precision of point cloud fusion is maintained at a relatively high level.

By taking a pixel point p in a current frame depth map D as an example, the implementation mode for detecting whether the depth of the pixel point in the current frame depth map is valid is exemplarily illustrated.

Regarding the pixel point p in the current frame depth map D, the pixel point p is projected back to the 3D space using its depth D(p) to obtain a 3D point P, where the back projection calculation formula is as follows:

P=T⁻¹*(D(p)*π⁻¹(p)) (1)

where π represents a projection matrix, where the projection matrix is a transformation matrix from a camera coordinate system to a pixel coordinate system, a perspective projection mode is adopted, and the projection matrix may be calibrated in advance, or may be obtained by means of calculation; π⁻¹ represents an inverse matrix of the projection matrix, T represents rigid transformation of a world coordinate system corresponding to the current depth map D to the camera coordinate system, and T⁻¹ is inverse transformation of T.

Then, the pixel point p is projected to a reference frame D′ by using intrinsic and extrinsic parameters of a camera to obtain a projection position p′ and a projection depth d_{p′}.

p′=π(T′*P) (2)

where T′ represents rigid transformation of a reference frame D′ (the rigid transformation of a world coordinate system corresponding to the reference frame D′ to the camera coordinate system), and the projection depth d_{p′} represents third dimensional coordinates of a projection point obtained by calculation after projection.

Here, whether a depth value of the pixel point p satisfies the depth consistency condition is determined according to whether a difference between the projection depth d_{p′} and a depth value D′ (p′) of the point p′ exceeds the first set depth threshold, where D′ (p′) is an observed depth of the projection position per se in the reference frame, and usually, the difference between the projection depth d_{p′} and the depth value D′ (p′) may not be too large. If the difference between the projection depth d_{p′} and the depth value D′ (p′) of the point p′ is too large, blocking or other errors may occur, and at this time, the depth of the pixel point may be unreliable.

In order to reduce the problem of inconsistency of depths of pixels caused by blocking, it can be configured that the depth of the pixel point p is determined to be valid in a case where the pixel point p in the current frame and the corresponding pixel points in over 60% of the reference frame depth maps satisfy the depth consistency condition, which is specifically represented by the following formulas:

$$\begin{matrix}C ( p ) = \{ \begin{matrix}1 & {\sum }_{k = 1}^{N} C ( {p}_{k}^{′} ) > δ , δ = 0.6 * N \\ 0 & others\end{matrix} & ( 3 ) \\ ( C ( {p}_{k}^{′} ) = \{ \begin{matrix} & 1 \vert {d}_{{p}_{k}^{′}} - {D}^{′} ( {p}_{k}^{′} ) \vert < τ \\ 0 & others\end{matrix} ) & ( 4 ) \\ {p}_{k}^{′} = π ( {T}_{k}^{′} * {T}_{k}^{- 1} * ( D ( p ) * {π}^{- 1} ( p ) ) ) & ( 5 )\end{matrix}$$

where p′ₖ represents the projection position obtained when the pixel point p is projected to the k^{th} reference frame; d_{p′}_{ₖ} represents the projection depth obtained when the pixel point p is projected to the k^{th} reference frame; D′(p′ₖ) represents the depth value of the projection position p′ₖ in the k^{th} reference frame; T′ₖ represents rigid transformation of a word coordinate system corresponding to the k^{th} reference frame to the camera coordinate system; Tₖ⁻¹ represents inverse transformation of T′ₖ; N represents the total number of the reference frame depth maps; C(p′ₖ) is used for determining whether the pixel point p and the corresponding point in the k^{th} reference frame satisfy the depth consistency condition; if C(p′ₖ) is equal to 1, it indicates that the pixel point p and the corresponding point in the k^{th} reference frame satisfy the depth consistency condition; if C(p′ₖ) is equal to 0, it indicates that the pixel point p and the corresponding point in the k^{th} reference frame do not satisfy the depth consistency condition; δ represents the set number of reference frames, and it should be noted that the value of δ in formula (3) is merely an example of the value of δ in the embodiments of the present disclosure, and δ may not be equal to 0.6N; C(p) is used for determining whether the depth of the pixel point p is valid; if C(p) is equal to 1, it indicates that the pixel point p is valid; if C(p) is equal to 0, it indicates that the pixel point p is invalid.

After the depth-valid pixel point in the current frame depth map is obtained, according to the at least two influence factors in the scene information and/or the camera information, a depth confidence of each depth-valid pixel point is determined.

In the embodiments of the present disclosure, the scene information may be at least one influence factor in a scene structure and a scene texture, and the camera information at least includes a camera configuration. The scene structure and the scene texture respectively indicate a structure feature and a texture feature of a scene. For example, the scene structure indicates upward orientation of the surface of the scene or other structure information, and the scene texture is photometric consistency or other texture features. The photometric consistency is a texture feature provided based on the following principles: photometry from different angles at the same point is consistent, and therefore, the photometric consistency is used for measuring the scene texture; and the camera configuration may be a distance from the camera to the scene and other camera configuration items.

In some embodiments, the depth confidence of the pixel point in the current frame depth map is determined according to the at least two influence factors in the scene structure, the camera configuration, and the scene texture.

In the prior art, when the depth confidence is calculated, either merely the camera configuration is considered, or merely the scene texture is considered, and thus the reliability degree of the depth confidence of the depth map is relatively low; moreover, because the precision degree of the depth map is related to information of the scene and the camera, and in particular to factors in three aspects such as the scene structure, the camera configuration and the scene texture, in the embodiments of the present disclosure, the depth confidence of the pixel point is obtained by considering the at least two factors in the scene structure, the camera configuration and the scene texture, and the reliability of the depth confidence of the pixel point is improved.

Regarding the implementation mode for determining, according to the at least two influence factors in the scene information and/or the camera information, the depth confidence of the pixel point in the current frame depth map, in one example, the depth confidence of the pixel point in the current frame depth map is determined according to at least two influence factors selected from any one of the scene information or the camera information, or at least two influence factors simultaneously selected from the scene information and the camera information.

Here, the implementation mode for determining the depth in the current frame depth map is valid is explained in the foregoing embodiments. Details are not described herein again.

It is understood that the depth confidence may be used for measuring the precision degree of the depth map, and the precision degree of the depth map is related to the factors in the three aspects such as the scene structure, the camera configuration and the scene texture. On this basis, in one implementation mode, weights corresponding to the at least two influence factors in the scene structure, the camera configuration, and the scene texture are respectively obtained for the pixel point in the current frame depth map; and the weights corresponding to the at least two influence factors are fused to obtain the depth confidence of the pixel point in the current frame depth map.

It can be seen that in the embodiments of the present disclosure, the depth confidence of the pixel point may be determined by comprehensively considering the weights of at least two factors in the scene structure, the scene texture, and the camera configuration, and therefore, the reliability of the depth confidence is improved. Moreover, the reliability of point cloud fusion processing is improved.

Regarding the implementation mode for respectively obtaining, for the pixel point in the current frame depth map, the weights corresponding to the at least two influence factors in the scene structure, the camera configuration, and the scene texture, exemplarily, the weights corresponding to at least two influence factors in the scene structure, the camera configuration, and the scene texture are respectively obtained according to attribute information of the pixel point in the current frame depth map, the attribute information at least including: a position and/or a normal vector.

Optionally, in order to obtain the weights corresponding to the at least two influence factor in the scene structure, the camera configuration, and the scene texture, a positional relationship between the camera and the pixel point, a parameter of the camera, and other parameters are further considered.

It can be seen that as the attribute information of the pixel point is obtained in advance, the weights corresponding to at least two influence factors in the scene structure, the camera configuration, and the scene texture are obtained more easily, and Moreover, the depth confidence of the pixel point in the current frame depth map is obtained.

Regarding the implementation mode for fusing the weights corresponding to the at least two influence factors to obtain the depth confidence of the pixel point in the current frame depth map, exemplarily, the weights corresponding to the at least two influence factors are multiplied to obtain a joint weight; and the depth confidence of the pixel point in the current frame depth map is obtained according to the joint weight.

Optionally, the joint weight may be taken as the depth confidence of the pixel point in the current frame depth map, and the depth confidence of the corresponding point in the previous frame is adjusted by using the joint weight, to obtain the depth confidence of the pixel point in the current frame.

It can be seen that by multiplying the weights corresponding to the at least two influence factors, the depth confidence of the pixel point in the current frame depth map is obtained easily, which is easily implemented.

In a specific example of the present discourse, the depth confidence may indicates the joint weight of the scene structure, the camera configuration, and the photometric consistency, that is, including a geometric structure-based weight item, a camera configuration-based weight item, and a photometric consistency-based weight item.

The geometric structure-based weight item, the camera configuration-based weight item, and the photometric consistency-based weight item are explained as follows.

1) The geometric structure-based weight item (geometric weight item)

The depth accuracy is related to orientation of the surface of the scene, and when the area parallel with an imaging plane of the camera is higher than an inclined area in depth accuracy, the geometric weight item is defined as follows:

$${w}_{g} ( p ) = \{ \begin{matrix}\frac{〈 {n}_{p} , {v}_{p} 〉 - cos ( {α}_{max} )}{1 - cos ( {α}_{max} )} & a cos ( {n}_{p} , {v}_{p} ) \leq {α}_{max} \\ 0 & others\end{matrix} \qquad ( 6 )$$

where w_{g} (p) represents the geometric weight item of the three-dimensional space point P corresponding to the pixel point in the current frame depth map; nₚ represents a unit normal vector of the pixel point p; vₚ represents a unit vector from the point p to an optical center of the camera; αₘₐₓ represents an allowable maximum angle (75-90 degrees) between nₚ and vₚ; when the angle between nₚ and vₚ exceeds αₘₐₓ, the geometric weight item is 0, indicating that the point is unreliable; [symbol] nₚ,vₚ [symbol] represents a point multiplication operation between nₚ and vₚ; and a cos(nₚ, vₚ) represents an angle between nₚ and vₚ.

2) The camera configuration-based weight item (camera weight item)

The depth accuracy is related to the distance from the surface to the camera. In a general situation, the farther the distance is, the more inaccurate the depth value is. In the embodiments of the present disclosure, the camera weight item is defined as follows:

w_{c}(p)=1−e^{-λξ} (7)

where w_{c}(p) represents a camera weight item of the three-dimensional space point P corresponding to the pixel point in the current frame depth map; λ is a set penalty factor; and ξ is a pixel offset generated when the pixel point p moves along the projecting direction by a distance. The pixel offset represents the distance between the projection point and an original pixel point, and the projection point is a pixel point obtained after the three-dimensional space point P changes slightly and then is projected to the current frame.

In actual application, the distance by which the point p moves along the projecting direction may be configured as: (d′ₘₐₓ−d′ₘᵢₙ)×1/600, where (d′ₘᵢₙ, d′ₘₐₓ)=(0.25 m, 3 m). A is used for determining an influence level of to the camera weight item, where the value range is between 0 and 1 (including boundary points), for example, 0.5.

3) The photometric consistency-based weight item

Here, the photometric consistency-based weight item is calculated using the Normalized Cross Correlation (NCC) or other parameters. By calculating the photometric consistency weight item using NCC, a certain anti-interference ability to the change of illumination is defined. The process of calculating the photometric consistency weight item using the NCC is exemplarily illustrated.

The formula for the photometric consistency-based weight item is as follows:

$${w}_{ph} ( p ) = \{ \begin{matrix}NCC ( p ) & NCC ( p ) \geq thr \\ 0 & others\end{matrix} \qquad ( 8 )$$

where wₚₕ(p) represents the photometric consistency weight item of the three-dimensional space point P corresponding to the pixel point in the current frame depth map, and thr represents a set threshold. In one example, thr is equal to 0.65, and the size of the NCC window is 5*5. If a plurality of reference frames exist, the NCC values calculated from each reference frame and the current frame are subjected to processing such as weighted average or median, to obtain a final NCC(p).

In some other embodiments, the NCC value may be used for measuring the photometric consistency. The higher the NCC is, the higher the consistency is. Therefore, interception processing is not required, that is, NCC(p) can be directly taken as wₚₕ(p).

After the geometric structure-based weight item, the camera configuration-based weight item, and the photometric consistency-based weight item are calculated, the joint weight w(p) is obtained according to the following formula:

w(p)=w_{g}(p)*w_{c}(p)*wₚₕ(p) (9)

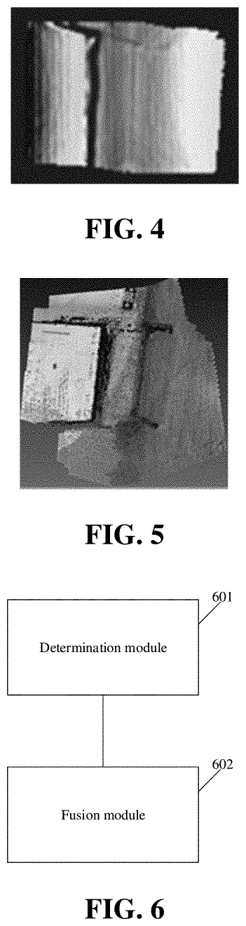

In the embodiments of the present disclosure, the joint weight is directly taken as the depth confidence value of the pixel point p, and the depth confidence map is generated according to the depth confidence obtained by calculation. FIG. 4 is a depth confidence map generated based on technical solutions of embodiments of the present disclosure on the basis of FIGS. 2 and 3. Obviously, in other embodiments, the depth confidence of the corresponding point in the previous frame is adjusted using the joint weight, to obtain the depth confidence of the pixel point in the current frame.

It should be noted that in the embodiments of the present discourse, the depth confidences of all the pixel points in the current frame depth map are determined according to the at least two influence factors in the scene information and/or the camera information, and the depth confidence of the depth-valid pixel point in the current frame depth map is also determined according to the at least two influence factors in the scene information and/or the camera information, so that the precision of point cloud fusion processing is improved.

In some embodiments, a surface element is used to indicate each pixel point or each depth-valid pixel point in the current frame depth map, each surface element at least including the depth confidence of the corresponding pixel point. Moreover, a surface element set of the current frame depth map is adjusted to implement point cloud fusion processing of the current frame depth map.

Optionally, each surface element further includes the position, normal vector, interior point weight, and exterior point weight of the corresponding pixel point, and obviously, the surface element may further include a color of the corresponding pixel point and the like, where the interior point weight is configured to indicate a probability that the corresponding pixel point is an interior point, the exterior point weight is configured to indicate a probability that the corresponding pixel point is an exterior point, and the depth confidence of the pixel point is defined as a difference between the interior point weight and the exterior point weight. For example, initially, the interior point weight is w(p), and the exterior point weight is 0. In the embodiments of the present disclosure, the interior point indicates a pixel point of neighborhood inside the surface element set of the current frame depth map, and the exterior point indicates a pixel point of neighborhood outside the surface element set of the current frame depth map.

It can be seen that as the surface element includes information such as the position, normal vector, interior point weight, and exterior point weight of the point, multiple attribute information of a point may be easily added using surface element-based indication, and moreover, point cloud fusion processing is accurately implemented on the basis of comprehensive consideration of the multiple attribute information of the point.

The surface element is one of the important modes to express a three-dimensional structure of a scene. The surface element includes coordinates of the three-dimensional point P, a normal vector nₚ of the pixel point p, an interior point weight Wₚ⁽ⁱⁿ⁾, and an exterior point weight Wₚ^{(out)}. Here, the position of the corresponding pixel point p is represented by the coordinates of the three-dimensional point P, and this mode of representation may unify positions of points under the same reference coordinates for ease of viewing and comparison, thereby facilitating subsequent processing. If the coordinates of the pixel point are used, each surface element coordinate system may be different, and frequent conversion is required in processing.

In the embodiments of the present disclosure, the purpose of point cloud fusion is to maintain a high-quality surface element set, and the fusion process thereof is also a fusion process of surface elements.

In the embodiments of the present disclosure, after the depth confidence of each pixel point or depth-valid pixel point in the current frame depth map, depth confidence-based surface element fusion is executed. That is, according to a surface element set of a current frame, set update is performed on an existing surface element set of the updated previous frame to obtain an existing surface element set of the updated current frame, where the existing surface element set of the updated current frame indicates a point cloud fusion processing result of the current frame depth map, and the surface element set of the current frame includes a set of surface elements corresponding to the depth-valid pixel points in the current frame depth map. Particularly, for an initial frame, after a surface element set of the initial frame is obtained, depth confidence-based surface element fusion is not executed, and instead, the depth confidence-based surface element fusion is executed from the second frame.

Here, the set update includes at least one of the following operations: surface element addition, surface element update, or surface element deletion. In the embodiments of the present disclosure, the process of updating the existing surface element set according to the surface element set of the current frame may be taken as: a process of fusing the surface element set of the current frame and the existing surface element set.

It can be seen that in the embodiments of the present disclosure, the point cloud fusion processing is implemented using surface element-based indication. Moreover, as the surface element may indicate attribute information of a point, point cloud fusion processing is highly efficiently implemented according to the attribute information of the point.

Here, after point cloud fusion processing according to the solutions of the embodiments of the present disclosure, a schematic diagram of point cloud data after fusion. FIG. 5 is a schematic diagram of fused point cloud data generated based on technical solutions of embodiments of the present disclosure on the basis of FIGS. 3 and 4.

The surface element addition, the surface element update, and the surface element deletion are respectively and exemplarily illustrated as follows.

1) Surface Element Addition

During initialization, the depth map of the first frame is added to the existing surface element set as a new surface element as a whole, and the interior point weight and the exterior point weight of the surface element are simultaneously updated. For example, during initialization, the interior point weight is w(p), and the exterior point weight is 0.

If a first surface element which is not covered by the existing surface element set of the updated previous frame exists in the surface element set of the current frame, the first surface element is added to the existing surface element set of the updated previous frame. As the first surface element is not the surface element which is not covered by the existing surface element set of the updated previous frame, the surface element of the existing surface element set of the updated previous frame is required to be added. Moreover, a point cloud fusion processing result in line with actual needs is obtained by using the surface element addition operation.

During actual implementation, the surface element of the existing surface element set of the updated the previous frame is projected to the surface element set of the current frame. During projection, if a situation where the first surface element of the current frame is covered by the surface element of the existing surface element set of the updated previous frame exists, an update or deletion operation for the first surface element is performed. If a situation where the first surface element of the current frame is not covered by the surface element of the existing surface element set of the updated previous frame exists, an addition operation for the first surface element is performed, i.e., the non-covered surface element is added to the existing surface element set.

2) Surface Element Update

When the surface element in the existing surface element set of the updated previous frame is projected to the current frame, the projection depth of the projection point is recorded as d_{pold}, and the measured depth of the surface element in the surface element set in the current frame is recorded as dₚ, where the projection depth d_{pold} may be obtained using the formula (2). Here, the update of the surface element may be explained in the following different situations.

(a) In some embodiments, when the above conditions are all met: a second surface element covered by the existing surface element set of the updated previous frame exists in the surface element set of the current frame, a depth of the second surface element is greater than a projection depth of a corresponding surface element in an existing surface element set of the updated previous frame, and the difference between the depth of the second surface element and the projection depth of the corresponding surface element in the existing surface element set is greater than or equal to a first set depth threshold, it is considered that blocking happens because a surface different from the existing surface element set after updating the previous frame is observed at the current frame, which is real In this case, the second surface element is added to the existing surface element set of the updated previous frame. For example, the second surface element may be added to the existing surface element set of the updated previous frame as an interior point.

Here, a value range is the first set depth threshold is 0.025 m to 0.3 m.

It can be seen that according to a relationship between the second surface element and the existing surface element set of the updated previous frame, it can be determined that the second surface element is a surface element required to be added to the existing surface element set of the updated previous frame. Moreover, a point cloud fusion processing result in line with actual needs is obtained by using the surface element addition operation.

In one specific example, if the measured depth dₚ is far greater than the projection depth d_{pold}, for example, if the ratio obtained by dividing the measured depth dₚ by the projection depth d_{pold} is greater than a first set ratio, for example, a value range of the first set ratio may be 4 to 10. If the measured depth dₚ is far greater than the projection depth d_{pold}, it is considered that blocking happens. In this case, visual conflict does not exist. In this case, the second surface element corresponding to the measured depth dₚ may be added to the existing surface element set of the updated previous frame as an interior point.

(b) In some embodiments, an exterior point weight value of the corresponding surface element in the existing surface element set of the updated previous frame is added when the following conditions are all met. The second surface element which is covered by the existing surface element set of the updated previous frame exists in the surface element set of the current frame, the depth of the second surface element is less than the projection depth of the corresponding surface element in the existing surface element set of the updated previous frame, and the difference between the depth of the second surface element and the projection depth of the corresponding surface element in the existing surface element set of the updated previous frame is greater than or equal to a second set depth threshold.

Here, a value range of the second set depth threshold is 0.025 m to 0.3 m.

It can be seen that if the depth of the second surface element is less than the projection depth of the corresponding surface element in the existing surface element set of the updated previous frame, it means that the second surface element is more likely to be an exterior point, and at this time, by adding the exterior point weight value of the corresponding surface element in the existing surface element set of the updated previous frame, surface element update is more in line with actual needs.

Specifically, a situation where the measured depth dₚ is far less than the projection depth d_{pold} is a situation which actually does not exist (visual conflict). For example, if the ratio obtained by dividing the measured depth dₚ by the projection depth d_{pold} is less than a second set ratio, for example, a value range of the second set ratio may be 0.001 to 0.01. In this case, an exterior point weight value of the corresponding surface element in the existing surface element set is added after the depth confidence of the corresponding pixel point, so that the depth confidence of the point after the update is reduced. For example, the exterior point weight value of the corresponding surface element in the existing surface element set of the updated previous frame is added according to the following formula:

Wₚ^{(out)}←W_{pold}^{(out)}+w(p) (10)

where W_{pold}^{(out)} represents an exterior point weight value of the corresponding surface element before the update in the existing surface element set of the updated previous frame, and Wₚ^{(out)} represents an exterior point weight value of the corresponding updated surface element in the existing surface element set of the updated the previous frame.

(c) In some embodiments, the position and the normal vector of the corresponding surface element in the existing surface element set of the updated previous frame are updated, and an interior point weight value of the corresponding surface element in the existing surface element set of the updated previous frame is added, when the following conditions are all met. The second surface element which is covered by the existing surface element set of the updated previous frame exists in the surface element set of the current frame, the difference between the depth of the second surface element and the projection depth of the corresponding surface element in the existing surface element set of the updated previous frame is less than a third set depth threshold, and an included angle between a normal vector of the corresponding surface element in the existing surface element set of the updated previous frame and a normal vector of the second surface element is less than or equal to a set angle value.

It can be seen that if the difference between the depth of the second surface element and the projection depth of the corresponding surface element in the existing surface element set of the updated previous frame is less than the third set depth threshold, and the included angle between the normal vector of the corresponding surface element in the existing surface element set of the updated previous frame and the normal vector of the second surface element is less than or equal to the set angle value, it means that a measured depth of the second surface element in the surface element set of the current frame is a valid depth, and at this time, by updating the position, the normal vector, and the interior point weight of the corresponding surface element, surface element update is more in line with actual needs.

Here, the third set depth threshold is a product of the depth of the corresponding surface element in the surface element set of the current frame and a third set ratio, where a value range of the third set ratio may be 0.008 to 0.012, a set angle value may be an acute angle value, for example, a range of the set angle value may be 30° to 60°. For example, a value range of the third set depth threshold is 0.025 m to 0.3 m.

In one specific example, if |dₚ−d_{pold}|/dₚ<0.01 and a cos(n_{pold},nₚ)≤45°, it indicates that the measured depth of the corresponding pixel point is valid depth, and in this case, a depth, a normal, and an interior point weight of the corresponding surface element in the existing surface element set of the updated previous frame are updated. Here, n_{pold} represents the normal vector of the corresponding surface element in the existing surface element set of the updated previous frame; d_{pold} represents a projection depth of the corresponding surface element in the existing surface element set of the updated previous frame; a cos(n_{pold},nₚ) represents an included angle between the normal of the surface elements in the existing surface element set of the updated previous frame and the surface element set of the current frame, 45° being a set angle value, 0.01 being the third set ratio, and a product 0.01 dₚ of the included angle and the depth of the second surface element of the current frame represents the third set depth threshold.

For example, the formula for updating the position, the normal, and the interior point weight of the corresponding surface element in the existing surface element set of the updated previous frame may be:

$$\begin{matrix}{X}_{p} ← \frac{{W}_{p o l d}^{( i n )} {X}_{p o l d} + w ( p ) {X}_{p}}{{W}_{p o l d}^{( in )} + w ( p )} & ( 11 ) \\ {W}_{p}^{( in )} ← {W}_{p o l d}^{( in )} + w ( p ) & ( 12 )\end{matrix}$$

where Xₚ includes a depth and a normal of a surface element, X_{pold} represents a depth and a normal of the surface element before the update, and W_{pold}⁽ⁱⁿ⁾ represents an interior point weight of the surface element before the update. The depth and the normal of the surface element are both updated according to formula (11). In addition, when the position of the surface element is updated, in addition to the depth, the position of the corresponding pixel point of the surface element is also updated, for example, three-dimensional point coordinates corresponding to the pixel point are updated.

It can be seen that in situation (c), the interior point weight is weighted. When the interior point weight is weighted, weight information of a historical reference frame is used, and therefore, point cloud fusion processing has better robustness and accuracy.

(d) If the second surface element which is covered by the existing surface element set of the updated previous frame exists in the surface element set of the current frame, the difference between the depth of the second surface element and the projection depth of the corresponding surface element in the existing surface element set of the updated previous frame is less than the third set depth threshold, and the included angle between the normal vector of the corresponding surface element in the existing surface element set of the updated previous frame and the normal vector of the second surface element is greater than the set angle value, the exterior point weight value of the corresponding surface element in the existing surface element set of the updated previous frame is added.

In one specific example, when |dₚ−d_{pold}|/dₚ<0.01 and a cos(n_{pold}, nₚ)>45°, it indicates that the depth of the surface element satisfies the depth consistency but does not satisfy normal consistency. In this case, an exterior point weight of the corresponding surface element is updated according to formula (10).

It should be understood that in the embodiments of the present disclosure, considering the normal consistency during surface element fusion, for a point not satisfying the normal consistency, a weight for enabling the point to become an exterior point is added. As a depth difference in a fine structure is small and a normal change from different view angles is large, the depth difference may be averaged out if only simply fusion is applied. However, in the present method, an exterior point weight is updated, and the subtle depth difference is reserved, and therefore, processing on a fine structure by the point cloud fusion solution in the embodiments of the present disclosure is more effective.

(e) In some embodiments, if the measured depth dₚ and the projection depth d_{pold} do not satisfy any one of (a) to (d) above, it is considered that both the corresponding pixel points in the existing surface element set of the updated previous frame and the surface element set of the current frame are exterior points, and in this case, the surface element is not updated.

3) Surface Element Deletion

If a surface element satisfying a preset deletion condition exists in the surface element set of the current frame, the surface element satisfying the preset deletion condition in the surface element set of the current frame is deleted, where the surface element satisfying the preset deletion condition is: a surface element having a depth confidence lower than a set confidence threshold, i.e., a surface element of which a difference between the interior point weight and the exterior point weight is lower than a set confidence threshold.

It can be seen that by deleting a surface element having a relatively low depth confidence, a surface element having a relatively high depth confidence is reserved, and therefore, the reliability and accuracy of point cloud fusion are improved.

Here, the set confidence threshold is recorded as cₜₕᵣ, and the set confidence threshold cₜₕᵣ is pre-configured according to actual needs, for example, a value range of cₜₕᵣ is between 0.5 and 0.7. It is understood that the higher the set confidence threshold is, the more surface elements are deleted, and otherwise, the fewer surface elements are deleted. If the set confidence threshold is too small, surface elements having low quality will be reserved. Some voids may be generated after surface elements are deleted, and the voids may be filled by subsequent surface elements having higher depth confidences.

In existing methods, based on fusion of three-dimensional points, information of a normal is not taken into consideration. A mode of Winner Take All (WTA) is mainly used for processing of a weight item. In the embodiments of the present disclosure, point cloud fusion and redundancy elimination of point cloud are efficiently handled using surface element-based indication, moreover, a depth confidence is determined using multi-factor fusion, and the reliability of the depth confidence is improved, so that the reserved point cloud is more reliable. Moreover, in the embodiments of the present disclosure, normal information is added to determine a visual conflict relationship of point cloud, and moreover, with reference to a degree of reliability of a historical frame, the robustness and accuracy are better.

It can be seen that in the foregoing embodiments of the embodiments of the present disclosure, a depth confidence of a pixel point in a current frame depth map is first determined, and then point cloud fusion processing is performed based on the determined depth confidence.

It should be noted that in other embodiments of the present disclosure, a depth-valid pixel point in pixel points of a current frame depth map is first determined, and then point cloud fusion processing is performed based on the depth-valid pixel point.

In specific examples, according to at least one reference frame depth map, whether the depth of a pixel point in the current frame depth map is valid is detected; and then the depth-invalid pixel point in the current frame depth map is discarded, and point cloud fusion processing is performed according the depth-valid pixel point in the current frame depth map.

Here, the implementation mode for detecting whether the depth of the pixel point in the current frame depth map is valid is explained in the foregoing content. Details are not described herein again. For the implementation mode for performing point cloud fusion processing according the depth-valid pixel point in the current frame depth map, the depth confidence of the pixel point is not considered, and depth values in the overlapping area may be directly fused.

Using the solutions in the embodiments, real-time high-precision fusion of point cloud is implemented. For the input depth map of each frame, the existing surface element set after the update of the current frame is obtained by using both step 101 to step 102, so that redundant point cloud deletion and surface element set expansion or update operations are implemented. The technical solutions of the embodiments of the present disclosure are used for online real-time anchor placement and high-precision modeling, so that three-dimensional rendering and interactive games in augmented reality applications and three-dimensional object recognition in computer vision are effectively assisted.

An application scene of the embodiments of the present disclosure include, but is not limited to, the following scenes:

1) In a case where a user uses a mobile device having a depth camera to photograph a certain scene, the point cloud fusion method in the embodiments of the present disclosure is used to reconstruct point cloud of a scene in real time, and fuse redundant point cloud to provide a real-time three-dimensional reconstruction effect of a user terminal.

2) A user may use the mobile device having the depth camera to reconstruct scene point cloud in real time by using a point cloud fusion method in the embodiments of the present disclosure, and fuse redundant point cloud to provide an anchor placement function.

3) A surface structure of an object or a scene may be reconstructed by using point cloud reconstructed by the point cloud fusion method in the embodiments of the present disclosure, and then the reconstructed model is placed in a real environment, so that an augmented reality effect of a mobile terminal is obtained.

4) A surface structure of an object is reconstructed by using point cloud reconstructed by the point cloud fusion method in the embodiments of the present disclosure, and texture mapping is performed, so that a 3D photo album effect of the object is obtained.

On the basis of the point cloud fusion method provided in the foregoing embodiments, the embodiments of the present disclosure provide a point cloud fusion apparatus.

FIG. 6 is a schematic structural composition diagram of a point cloud fusion apparatus according to embodiments of the present disclosure. As shown in FIG. 6, the apparatus is located in an electronic device. The apparatus includes a determination module 601 and a fusion module 602, where

the determination module 601h is configured to determine, according to at least two influence factors in scene information and/or camera information, depth confidences of pixel points in a current frame depth map, where the scene information and the camera information each at least includes one influence factor; and

the fusion module 602 is configured to perform point cloud fusion processing on the pixel points in the current frame depth map according to the depth confidences.

In one implementation mode, the determination module 601 is configured to obtain a depth-valid pixel point in the current frame depth map, and determine, according to the at least two influence factors in the scene information and/or the camera information, a depth confidence of each depth-valid pixel point; and

the fusion module is configured to perform point cloud fusion processing on the depth-valid pixel point in the current frame depth map according to the depth confidence.

In one implementation mode, the determination module 601 is configured to detect, according to at least one reference frame depth map, whether the depth of a pixel point in the current frame depth map is valid, and reserve the depth-valid pixel point in the current frame depth map.

In one implementation mode, the at least one reference frame depth map includes at least one frame depth map obtained before obtaining the current frame depth map.

In one implementation mode, the determination module 601 is configured to perform depth consistency check on the depths of the pixel points in the current frame depth map by using at least one reference frame depth map, and determine the pixel point passing the depth consistency check as depth-valid, and the pixel point not passing the depth consistency check as depth-invalid.

In one implementation mode, the determination module 601 is configured to obtain a plurality of reference frame depth maps, determine whether a first pixel point in the current frame depth map and a corresponding pixel point in each of the reference frame depth maps satisfy a depth consistency condition, if the quantity of the corresponding pixel points satisfying the depth consistency condition with the first pixel point is greater than or equal to a set value, determine that the first pixel point passes the depth consistency check, and if the quantity of the corresponding pixel points satisfying the depth consistency condition with the first pixel point is less than a set value, determine that the first pixel point does not pass the depth consistency check, the first pixel point being any one pixel point in the current frame depth map.

In one implementation mode, the determination module 601 is configured to project the first pixel point to each of the reference frame depth maps to obtain the projection position and projection depth of a projection point in each of the reference frame depth maps, obtain a measured depth value of the projection position in each of the reference frame depth maps, obtain a difference between the projection depth of the projection point and the measured depth value of the projection position in each of the reference frame depth maps, if the difference is less than or equal to a first set depth threshold, determine that the first pixel point and the corresponding pixel point in the corresponding reference frame depth map satisfy the depth consistency condition, and if the difference is greater than the first set depth threshold, determine that the first pixel point and the corresponding pixel point in the corresponding reference frame depth map do not satisfy the depth consistency condition.

In one implementation mode, the scene information includes at least one influence factor in a scene structure and a scene texture, and the camera information at least includes a camera configuration.

In one implementation mode, the determination module 601 is configured to respectively obtain, for the pixel point in the current frame depth map, weights corresponding to at least two influence factors in the scene structure, the camera configuration, and the scene texture, and fuse the weights corresponding to the at least two influence factors to obtain the depth confidence of the pixel point in the current frame depth map.

In one implementation mode, the determination module 601 is configured to respectively obtain the weights corresponding to at least two influence factors in the scene structure, the camera configuration, and the scene texture according to attribute information of the pixel point in the current frame depth map, the attribute information at least including: a position and/or a normal vector.

In one implementation mode, the determination module 601 is configured to multiply the weights corresponding to the at least two influence factors to obtain a joint weight; and obtain the depth confidence of the pixel point in the current frame depth map according to the joint weight.

In one implementation mode, the fusion module 602 is configured to use a surface element to indicate each pixel point in the current frame depth map, each surface element at least including the depth confidence of the corresponding pixel point; and

the fusion module 602 is configured to perform, according to a surface element set of a current frame, set update on an existing surface element set of an updated previous frame, to obtain an existing surface element set of the updated current frame, where the existing surface element set of the updated current frame indicates a point cloud fusion processing result of the current frame depth map, the surface element set of the current frame includes a set of surface elements corresponding to the depth-valid pixel points in the current frame depth map, and

the set update includes at least one operation in surface element addition, surface element update, and surface element deletion.

In one implementation mode, each of the surface elements further includes the position, normal vector, interior point weight, and exterior point weight of the corresponding pixel point, where the interior point weight is configured to indicate a probability that the corresponding pixel point is an interior point, the exterior point weight is configured to indicate a probability that the corresponding pixel point is an exterior point, and a difference between the interior point weight and the exterior point weight is configured to indicate the depth confidence of the corresponding pixel point.

In one implementation mode, the fusion module 602 is configured to, if a first surface element which is not covered by the existing surface element set of the updated previous frame exists in the surface element set of the current frame, add the first surface element to the existing surface element set of the updated previous frame.

In one implementation mode, the fusion module 602 is configured to, add the second surface element to the existing surface element set of the updated previous frame when the following conditions are met: a second surface element covered by the existing surface element set of the updated previous frame exists in the surface element set of the current frame, a depth of the second surface element is greater than a projection depth of a corresponding surface element in the existing surface element set of the updated previous frame, and a difference between the depth of the second surface element and the projection depth of the corresponding surface element in the existing surface element set of the updated previous frame is greater than or equal to a first set depth threshold.

In one implementation mode, the fusion module 602 is configured to, add an exterior point weight value of the corresponding surface element in the existing surface element set of the updated previous frame when the following conditions are met: the second surface element which is covered by the existing surface element set of the updated previous frame exists in the surface element set of the current frame, the depth of the second surface element is less than the projection depth of the corresponding surface element in the existing surface element set of the updated previous frame, and the difference between the depth of the second surface element and the projection depth of the corresponding surface element in the existing surface element set of the updated previous frame is greater than or equal to a second set depth threshold.

In one implementation mode, the fusion module 602 is configured to, update the position and the normal vector of the corresponding surface element in the existing surface element set of the updated previous frame and add an interior point weight value of the corresponding surface element in the existing surface element set of the updated the previous frame, when the following conditions are met: the second surface element which is covered by the existing surface element set of the updated previous frame exists in the surface element set of the current frame, the difference between the depth of the second surface element and the projection depth of the corresponding surface element in the existing surface element set of the updated previous frame is less than a third set depth threshold, and an included angle between a normal vector of the corresponding surface element in the existing surface element set of the updated previous frame and a normal vector of the second surface element is less than or equal to a set angle value.

In one implementation mode, the fusion module 602 is configured to, if the second surface element which is covered by the existing surface element set of the updated previous frame exists in the surface element set of the current frame, the difference between the depth of the second surface element and the projection depth of the corresponding surface element in the existing surface element set of the updated previous frame is less than the third set depth threshold, and the included angle between the normal vector of the corresponding surface element in the existing surface element set of the updated previous frame and the normal vector of the second surface element is greater than the set angle value, add the exterior point weight value of the corresponding surface element in the existing surface element set of the updated previous frame.

In one implementation mode, the fusion module 602 is configured to if a surface element satisfying a preset deletion condition exists in the surface element set of the current frame, delete the surface element satisfying the preset deletion condition in the surface element set of the current frame, where the surface element satisfying the preset deletion condition is: a surface element corresponding to a pixel point having a depth confidence lower than a set confidence threshold.

In addition, functional units in the embodiments may be integrated into one processing unit, or each of the units may exist alone physically, or two or more units may be integrated into one unit. The integrated unit may be implemented in the form of hardware, or may also be implemented in the form of a software functional unit.

When the integrated unit is implemented in the form of the software functional unit and sold or used as an independent product, the integrated unit may be stored in one computer readable storage medium. Based on such an understanding, the technical solutions in the embodiments or a part thereof contributing to the prior art may be essentially embodied in the form of a software product. The computer software product is stored in one storage medium and includes several instructions so that one computer device (which may be a personal computer, a server, a network device, and the like) or a processor implements all or some of the steps of the method in the embodiments. Moreover, the preceding storage medium includes: various media capable of storing program codes, such as a USB flash drive, a mobile hard disk drive, a Read-only Memory (ROM), a Random Access Memory (RAM), a floppy disk, and an optical disc.

Specifically, the computer program instruction corresponding to the point cloud fusion method in the embodiments may be stored in the storage medium, such as the optical disc, the hard disk, and the USB flash drive. When the computer program instruction corresponding to the point cloud fusion method in the storage medium is read or implemented by one electronic device, any one point cloud fusion method of the foregoing embodiments is implemented.

Based on the same technical concept of the foregoing embodiments, the embodiments of the present disclosure further provide a computer program, where any one of the point cloud fusion methods is implemented when the computer program is executed by a processor.

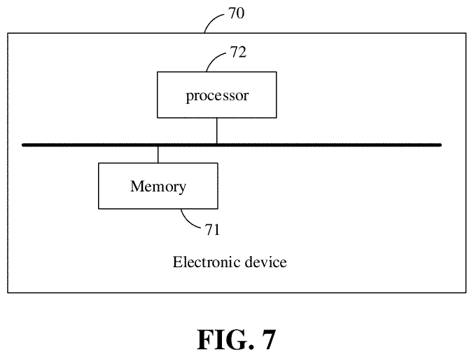

Based on the technical concept the same as that in the foregoing embodiments, with reference to FIG. 7 which shows an electronic device 70 provided by the embodiments of the present disclosure, the electronic device may include a memory 71 and a processor 72 which are connected to each other, where

the memory 71 is configured to store a computer program and data, and

the processor 72 is configured to execute the computer program stored in the memory to implement any one of the point cloud fusion methods according to the foregoing embodiments.

Based on the point cloud fusion method and apparatus, the electronic device, and the computer storage medium provided in the embodiments of the present disclosure, according to at least two influence factors in scene information and/or camera information, a depth confidence of a pixel point in a current frame depth map is determined, where the scene information and the camera information each at least includes one influence factor; and point cloud fusion processing is performed on the pixel point in the current frame depth map according to the depth confidence. In this way, in the embodiments of the present discourse, a depth confidence of a pixel point is determined by comprehensively considering multiple factors, and therefore, the reliability of the depth confidence is improved. Moreover, the reliability of point cloud fusion processing is improved.

In practical application, the foregoing memory 71 may be a volatile memory such as an RAM, or a non-volatile memory such as an ROM, a flash memory, a Hard Disk Drive (HDD) or a Solid-State Drive (SSD), or a combination of the foregoing various memories, and provides instructions and data for the processor 72.

The foregoing processor 72 may be at least one of the ASIC, the DSP, the DSPD, the PLD, the FPGA, the CPU, the controller, the microcontroller, or the microprocessor. It may be understood that for different devices, the electronic device configured to implement the function of the foregoing processor may also be other device, and the embodiments of the present disclosure does not specifically limit this.

By means of the description of the foregoing implementations, a person skilled in the art can clearly know that the method of the foregoing embodiments can be implemented by software and a necessary general-purpose hardware platform, and also can be implemented by the hardware, but in many cases, the former is a better embodiment. Based on such an understanding, the technical solutions of the present disclosure or a part thereof contributing to the prior art may be essentially embodied in the form of a software product. The computer software product is stored in one storage medium (such as the ROM/RAM, the floppy disk, and the optical disc) and includes several instructions so that one computer device (which may be a personal computer, a server, a network device, and the like) implements the method in the embodiments of the present disclosure.

The embodiments of the present disclosure are described above with reference to the accompanying drawings. Different embodiments in the present application may be mutually combined without violating logic. The different embodiments emphasize different aspects, and for a part not described in detail, reference may be made to descriptions of other embodiments. The present disclosure is not limited to the foregoing detailed description. The foregoing detailed description only is schematic but not restrictive. Under the motivation of the present disclosure, a person skilled in the art may make many forms without departing from the purpose of the present disclosure and the scopes of protection of the claims, and these all fall within the scope of protection of the present disclosure.

1. A point cloud fusion method, comprising:
determining, according to at least two influence factors in scene information and/or camera information, depth confidences of pixel points in a current frame depth map, wherein the scene information and the camera information each at least comprises one influence factor; and
performing point cloud fusion processing on the pixel points in the current frame depth map according to the depth confidences.

2. The method according to claim 1, wherein determining, according to the at least two influence factors in the scene information and/or the camera information, the depth confidences of the pixel points in the current frame depth map comprises:
obtaining at least one depth-valid pixel point in the current frame depth map; and
determining, according to the at least two influence factors in the scene information and/or the camera information, a depth confidence of each of the at least one depth-valid pixel point; and
wherein performing point cloud fusion processing on the pixel points in the current frame depth map according to the depth confidences comprises:
performing point cloud fusion processing on the at least one depth-valid pixel point in the current frame depth map according to the depth confidences.

3. The method according to claim 2, wherein obtaining the at least one depth-valid pixel point in the current frame depth map comprises:
detecting, according to at least one reference frame depth map, whether depths of the pixel points in the current frame depth map are valid; and
reserving the at least one depth-valid pixel point in the current frame depth map, wherein the at least one reference frame depth map comprises at least one frame depth map obtained before the current frame depth map is obtained.

4. The method according to claim 3, wherein detecting, according to the at least one reference frame depth map, whether the depths of the pixel points in the current frame depth map are valid comprises:
performing depth consistency check on the depths of the pixel points in the current frame depth map by using the at least one reference frame depth map; and
determining a depth of a pixel point passing the depth consistency check as valid, and determining a depth of a pixel point not passing the depth consistency check as invalid.

5. The method according to claim 4, wherein performing depth consistency check on the depths of the pixel points in the current frame depth map by using the at least one reference frame depth map comprises:
obtaining a plurality of reference frame depth maps;
determining whether a first pixel point in the current frame depth map and a corresponding pixel point in each of the plurality of reference frame depth maps satisfy a depth consistency condition, the first pixel point being any one of the pixel points in the current frame depth map; and
if a quantity of corresponding pixel points satisfying the depth consistency condition with the first pixel point is greater than or equal to a set value, determining that the first pixel point passes the depth consistency check; or if the quantity of corresponding pixel points satisfying the depth consistency condition with the first pixel point is less than the set value, determining that the first pixel point does not pass the depth consistency check.

6. The method according to claim 5, wherein determining whether the first pixel point in the current frame depth map and the corresponding pixel point in each of the plurality of reference frame depth maps satisfy the depth consistency condition comprises:
projecting the first pixel point to each of the plurality of reference frame depth maps to obtain a projection position and a projection depth of a projection point in each of the plurality of reference frame depth maps;
obtaining a measured depth value of the projection position in each of the plurality of reference frame depth maps;
obtaining a difference between the projection depth of the projection point and the measured depth value of the projection position in each of the plurality of reference frame depth maps; and
if the difference is less than or equal to a first set depth threshold, determining that the first pixel point and a corresponding pixel point in its corresponding reference frame depth map satisfy the depth consistency condition; or if the difference is greater than the first set depth threshold, determining that the first pixel point and the corresponding pixel point in the corresponding reference frame depth map do not satisfy the depth consistency condition.

7. The method according to claim 1, wherein the scene information comprises at least one influence factor in a scene structure and a scene texture, and the camera information at least comprises a camera configuration.

8. The method according to claim 7, wherein determining, according to the at least two influence factors in the scene information and/or the camera information, the depth confidences of the pixel points in the current frame depth map comprises:
respectively obtaining, for the pixel points in the current frame depth map, weights corresponding to at least two influence factors in the scene structure, the camera configuration, and the scene texture; and
fusing the weights corresponding to the at least two influence factors to obtain the depth confidences of the pixel points in the current frame depth map.

9. The method according to claim 8, wherein respectively obtaining, for the pixel points in the current frame depth map, the weights corresponding to the at least two influence factors in the scene structure, the camera configuration, and the scene texture comprises:
respectively obtaining the weights corresponding to at least two influence factors in the scene structure, the camera configuration, and the scene texture according to attribute information of the pixel point in the current frame depth map, the attribute information at least comprising: a position and/or a normal vector.

10. The method according to claim 8, wherein fusing the weights corresponding to the at least two influence factors to obtain the depth confidences of the pixel points in the current frame depth map comprises:
multiplying the weights corresponding to the at least two influence factors to obtain a joint weight; and obtaining the depth confidences of the pixel points in the current frame depth map according to the joint weight.

11. The method according to claim 1, wherein performing point cloud fusion processing on the pixel points in the current frame depth map according to the depth confidences comprises:
indicating each of the pixel points in the current frame depth map by using at least one surface element, each of the at least one surface element at least comprising a depth confidence of a corresponding pixel point; and
performing, according to a surface element set of a current frame, set update on an existing surface element set of an updated previous frame, to obtain an existing surface element set of an updated current frame, wherein the existing surface element set of the updated current frame indicates a point cloud fusion processing result of the current frame depth map, and the surface element set of the current frame comprises a set of surface elements corresponding to depth-valid pixel points in the current frame depth map, and
wherein the set update comprises at least one of the following operations: surface element addition, surface element update, or surface element deletion.

12. The method according to claim 11, wherein each of the at least one surface element further comprises a position, a normal vector, an interior point weight, and an exterior point weight of the corresponding pixel point, wherein the interior point weight is configured to indicate a probability that the corresponding pixel point is an interior point, the exterior point weight is configured to indicate a probability that the corresponding pixel point is an exterior point, and a difference between the interior point weight and the exterior point weight is configured to indicate the depth confidence of the corresponding pixel point.

13. The method according to claim 11, wherein performing, according to the surface element set of the current frame, the set update on the existing surface element set of the updated previous frame comprises:
if a first surface element uncovered by the existing surface element set of the updated previous frame exists in the surface element set of the current frame, adding the first surface element to the existing surface element set of the updated previous frame.

14. The method according to claim 11, wherein performing, according to the surface element set of the current frame, the set update on the existing surface element set of the updated previous frame comprises:
adding a second surface element to the existing surface element set of the updated previous frame when the following conditions are met:
a second surface element covered by the existing surface element set of the updated previous frame exists in the surface element set of the current frame, a depth of the second surface element is greater than a projection depth of a corresponding surface element in the existing surface element set of the updated previous frame, and a difference between the depth of the second surface element and the projection depth of the corresponding surface element in the existing surface element set of the updated previous frame is greater than or equal to a first set depth threshold.

15. The method according to claim 12, wherein performing, according to the surface element set of the current frame, the set update on the existing surface element set of the updated previous frame comprises:
adding an exterior point weight value of a corresponding surface element in the existing surface element set of the updated previous frame when the following conditions are met:
a second surface element uncovered by the existing surface element set of the updated previous frame exists in the surface element set of the current frame, a depth of the second surface element is less than a projection depth of the corresponding surface element in the existing surface element set of the updated previous frame, and the difference between the depth of the second surface element and the projection depth of the corresponding surface element in the existing surface element set of the updated previous frame is greater than or equal to a second set depth threshold.

16. The method according to claim 12, wherein performing, according to the surface element set of the current frame, the set update on the existing surface element set of the updated previous frame comprises:
updating the position and the normal vector of a corresponding surface element in the existing surface element set of the updated previous frame and adding an interior point weight value of the corresponding surface element in the existing surface element set of the updated previous frame, when the following conditions are met:
a second surface element uncovered by the existing surface element set of the updated previous frame exists in the surface element set of the current frame, the difference between a depth of the second surface element and a projection depth of the corresponding surface element in the existing surface element set of the updated previous frame is less than a third set depth threshold, and an included angle between a normal vector of the corresponding surface element in the existing surface element set of the updated previous frame and a normal vector of the second surface element is less than or equal to a set angle value.

17. The method according to claim 12, wherein performing, according to the surface element set of the current frame, the set update on the existing surface element set of the updated previous frame comprises:
adding an exterior point weight value of a corresponding surface element in the existing surface element set of the updated previous frame when the following conditions are met:
a second surface element uncovered by the existing surface element set of the updated previous frame exists in the surface element set of the current frame, the difference between a depth of the second surface element and a projection depth of the corresponding surface element in the existing surface element set of the updated previous frame is less than a third set depth threshold, and an included angle between the normal vector of the corresponding surface element in the existing surface element set of the updated previous frame and the normal vector of the second surface element is greater than a set angle value.

18. The method according to claim 11, wherein performing, according to the surface element set of the current frame, the set update on the existing surface element set of the updated previous frame comprises:
if a surface element satisfying a preset deletion condition exists in the surface element set of the current frame, deleting the surface element satisfying the preset deletion condition in the surface element set of the current frame, wherein the surface element satisfying the preset deletion condition is: a surface element of the corresponding pixel point having a depth confidence lower than a set confidence threshold.

19. An electronic device, comprising a processor and a memory configured to store a computer program executable by the processor, wherein
the processor is configured to perform, when the computer program is executed, the following:
determining, according to at least two influence factors in scene information and/or camera information, depth confidences of pixel points in a current frame depth map, wherein the scene information and the camera information each at least comprises one influence factor; and
performing point cloud fusion processing on the pixel points in the current frame depth map according to the depth confidences.

20. A non-transitory computer-readable storage medium having a computer program stored thereon, wherein the computer program, when being executed by a processor, enables the processor to implement the following:
determining, according to at least two influence factors in scene information and/or camera information, depth confidences of pixel points in a current frame depth map, wherein the scene information and the camera information each at least comprises one influence factor; and
performing point cloud fusion processing on the pixel points in the current frame depth map according to the depth confidences.
